(19) United States
(12) Patent Application Publication
(10) Pub. No.: US 2002/0035521 A1
(43) Pub. Date: Mar. 21, 2002

(54) Appointment scheduling and method for secure to access to car keys for a loaner car

(76) Inventor: Raymond Vincent Powers, Nesconset, NY (US)

Correspondence Address: DARBY & DARBY P.C., 805 Third Avenue, New York, NY, 10022, US

(21) Appl. No.: 09/832,731

(22) Filed: Apr. 11, 2001

Related U.S. Application Data
(60) Provisional application No. 60/206,823, filed on May 15, 2000.
(60) Provisional application No. 60/196,563, filed on Apr. 11, 2000.

(51) Int. Cl. G06F 17/60

(52) U.S. Cl. 705/28

(57) ABSTRACT

A method is disclosed for providing a loaner car to a customer. In this method, the customer is provided with an appointment book maintained by the service center through a machine connected to a distributed computer network. The customer schedules a service appointment in the electronic appointment book and is prompted for a loaner car request. If the customer requests a loaner car, the request is pre-approved, a code for releasing car keys to the loaner car is established or received and then provided to the customer for opening a secure a lock box located at the service center. The car keys to the loaner car are released to the customer upon entry of the code at the lock box.

### RELATED SUBJECT MATTER

This application is related in subject matter to U.S. Provisional Application Ser. No. 60/206,823, filed May 15, 2000 and U.S. Provisional Application Ser. No. 60/196,563, filed Apr. 11, 2000, the disclosure of each is hereby incorporated by reference.

### FIELD OF THE INVENTION

The present invention relates to methods for scheduling work orders to treat problems with motorized vehicles through a distributed computer network such as the Internet and for secure access to keys for a loaner car.

### BACKGROUND OF THE INVENTION

Automobiles and other motorized vehicles have greatly improved our ability to get to and enjoy the places that we want to be. When those vehicles require service, however, that process can be very difficult because of our increased reliance on them for basic transportation.

Many people do not understand the problem that they may be having with a vehicle and often have to visit a local service station to discover the nature of the problem. Unless that person is willing to shop around at various service stations, he or she may not know whether he's getting a good price for treatment of the problem. Indeed, there are many tales about service stations that have charged for work that was not performed or needed. Compounding the situation is the fact that the problem may require that the vehicle remain at the service center for an extended period of time, with the owner being left without a vehicle. This is particularly true in the case of cars.

What is needed in the art has heretofore not been available is a system and method which enable problems with the car to be diagnosed through a distributor computer network such as the Internet. What is further needed in the art is a system which enables a person with a malfunctioning automobile or other motorized vehicle to schedule an appointment with a local service center in that person's geographic area. Other benefits in the art result from providing secure access to car keys to loaner cars to permit customers to drop of their own vehicles for service and have access to a loaner car in which to drive away and later return once their respective vehicles have been serviced. The art would further benefit by systems methods which combine these functionalities. The present invention satisfies these and other needs.

### SUMMARY OF THE INVENTION

The present invention concerns a method for providing a loaner car to a customer. In this method, the customer is provided with an appointment book maintained by the service center through a machine connected to a distributed computer network. The customer schedules a service appointment in the electronic appointment book and is prompted for a loaner car request. If the customer requests a loaner car, the request is pre-approved, a code for releasing car keys to the loaner car is established or received and then provided to the customer for opening a secure a lock box located at the service center. The car keys to the loaner car are released to the customer upon entry of the code at the lock box.

The present invention also provides a method for providing a price quote for treating the problem to a user who is situated remote from a service center, such as at a machine connectable to a distributed computer network.

In a method in accordance with a one aspect of the invention, the user is provided with an interactive interview at the user's machine. The interview process includes a series of questions concerning the problem and a corresponding series of responses. The responses are conveyed from the user's machine to a central computer connected to a distributed computer network. The user's machine also conveys to the central computer information concerning a geographic location of the user. The user's machine receives a diagnosis of the problem as well as a price quote for treating the problem from at least one service center in the geographic location of the user.

In another method in accordance with an additional aspect of the invention, the user is again provided with an interactive interview at the user's machine of the type described above. The responses are again conveyed from the user's machine to a central computer connected to a distributed computer network, as well as information concerning a geographic location of the user and the user's machine also receives a diagnosis of the problem. In this method, however, the user provides a selection of service centers within the geographic location to treat the diagnosed problem and the user is permitted to schedule an appointment at a selected service center.

In still another method in accordance with yet another aspect of the invention, the user is provided with an interactive interview at the user's machine of the type described above, with the responses being conveyed from the user's machine to a central computer connected to a distributed computer network, as well as information concerning a geographic location of the user. The problem is diagnosed by applying the responses to the questions to a rule base, and the diagnosis is provided to at least one service center in the geographic location of the user for a response. The user's machine then presents a price quote to treat the problem from each of the responding service centers.

These and other features, aspects and advantages of the invention can be further appreciated from the accompanying Figures, Description of the Figures, and Detailed Description of the Preferred Embodiment.

### DESCRIPTION OF THE FIGURES

FIG. 1 illustrates a network arrangement of hardware components for implementing a method in accordance with an embodiment of the invention;

FIGS. 2A-2B illustrate a process flow in accordance with an embodiment of the invention; and

FIG. 3 illustrates a process flow for obtaining a loaner car in accordance with an embodiment of the invention.

### DETAILED DESCRIPTION OF THE PREFERRED EMBODIMENT

By way of overview and introduction, methods are described in accordance with a preferred embodiment of the invention by which a person accesses a host computer through a distributed computer network such as the Internet and is able to diagnose a problem with an automobile, motorcycle, motorboat or other motorized vehicle, obtain a price quote for the diagnosis from a service center geographically close to the user, schedule an appointment to fix any problems with the vehicle, or a combination of these abilities. The method of the preferred embodiment provides diagnoses, price quotes, appointment scheduling, and loaner car reservations, although the inventive method itself need not provide all of these functions in a single embodiment thereof.

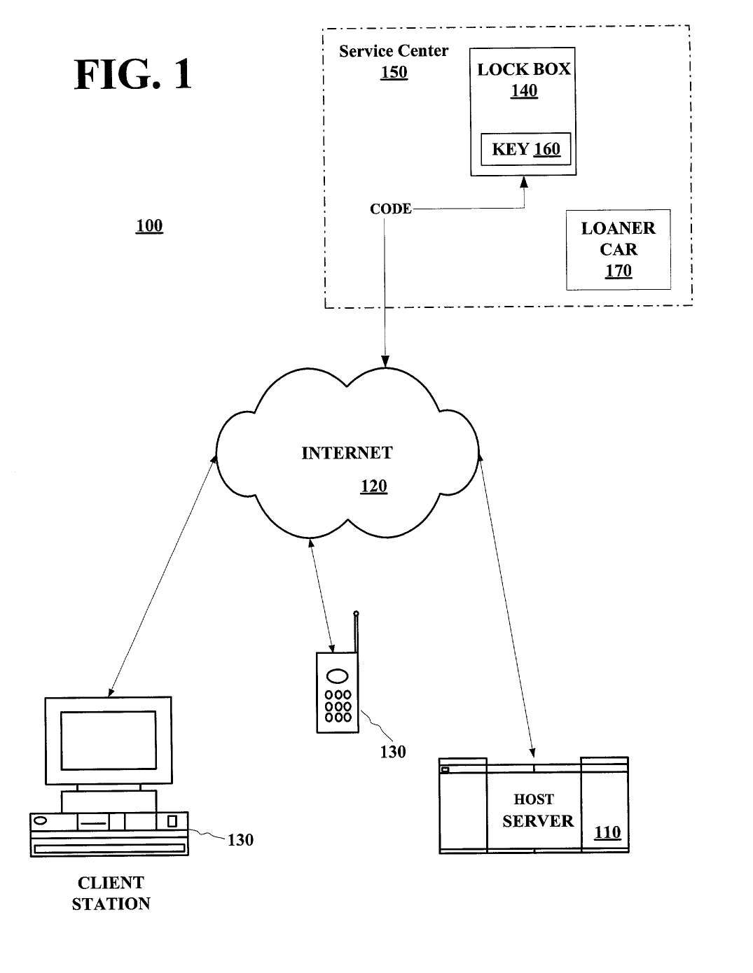

With reference now to FIG. 1, a network arrangement for implementing a method in accordance with the present invention is described. The network 100 includes a host server 110 which serves as a “central computer” and provides content over the Internet 120 to a plurality of distributed users that access the host server through client stations 130. The content provided by the host server 110 can be viewed by users through a web browser or other functionally equivalent software running at their respective client stations 130. In addition to content, the host server 110 executes a software application which implements the method of the preferred embodiment, as described below in connection with the other Figures. The client stations 130 can assume a variety of forms, including a home computer, a Palm Pilot, an Internet compliant telephone, or other Internet compliant communications device.

The host server 110 can be configured to support electronic commerce and provide goods and/or services for purchase or lease by the users who access it. Alternatively, e-commerce services can be provided by a different server (not shown). The host server 110 and the plural client stations 130 are configured to communicate with one another in a conventional manner over communication link through the Internet 120. In lieu of the Internet, communications can be through an intranet or extranet or between a host computer and a kiosk located nearby, as understood by those of skill in the art.

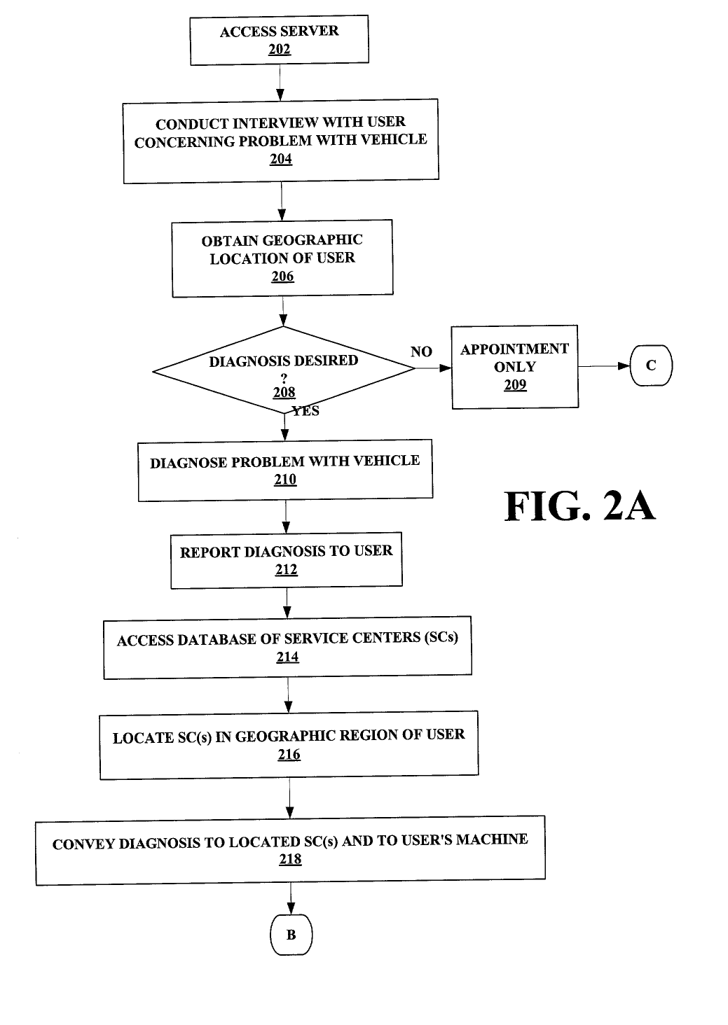

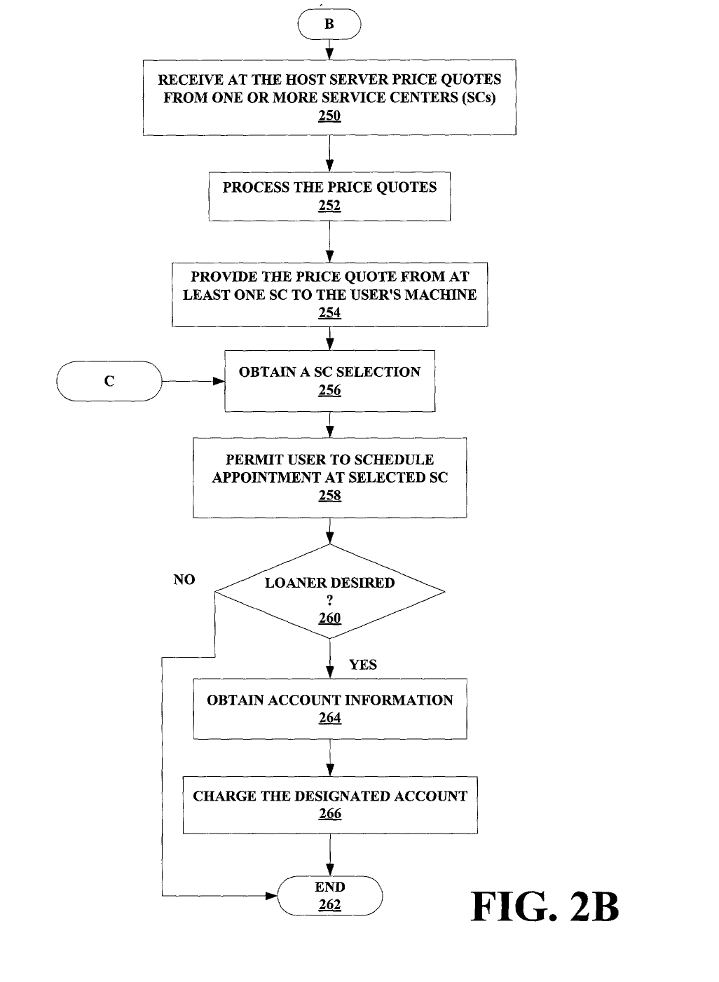

With reference now to FIGS. 2A and 2B, a process flow in accordance with the preferred embodiment of the invention is described. At step 202 a user accesses the host server or central computer 110 by establishing a communication link through the Internet 120 from a suitable client machine 130. Communications between the client machine and the central computer are conventional and form no part of the inventive method. The central computer provides a variety of content that may be of interest to the user. For example, the central computer can implement a Web site hosted by a dealership, a speciality repair shop, or an enthusiast, organization or club. The central computer provides files over the Internet which are displayable at the client station through the web browser or functionally equivalent software. At least one Web page includes a form or facility for conducting an interactive interview with the user by which information can be obtained concerning the problem the user is having in operating his or her vehicle.

At step 204, a user initiates an interactive interview with the central computer. The interactive interview comprises a series of questions posted by the host server concerning the possible problems that the user may be having. A corresponding series of responses are conveyed to the central computer by the user in response to each question. Preferably, the central computer dynamically selects and provides further questions to the user based on the responses. In the examples shown below, a user selects various complaints from a selection list or series of buttons that can be provided on the Web page that was sent to the client's machine by the host server. In the first two example complaints, a user has selected the problem “car won't start.” In the third to fifth example complaints, the user has selected the problem “brake pedal feels low.” In these examples, the same questions are provided to the user, but different answers are given in response. A rule base operating at the host server has rules for each diagnosis that can be given, with each complaint resolving into a different diagnosis as a function of the responses given by the user. Thus, for example, the responses to first complaint filtered out to a diagnosis of the probable cause for the problem as “dead battery,” whereas the diagnosis for the second complaint resulted in a probable cause of “starter failure.”

The software of the preferred embodiment includes routines operating at the host server 110 which diagnose the problem by accessing a rule base, as described above, and by accessing a knowledge base of information which is supplemented by the responses provided by the user. The interview can further include basic information, such as whether the car has an automatic or manual transmission, as will be appreciated by those of skill in the art, to assist in the diagnosis.

The interactive interview can include textual questions, visual illustrations, and aural prompting. Thus, the user can be asked, for example, whether the transmission is in park. The user also can be shown, for example, the connections to the car battery through an image or streamed video. Also, sounds can be provided to the user to assist the user in selecting whether the problem sounds like one thing or another.

### COMPLAINT 1: CAR WON'T START

1. Does engine “spin-over” attempting to start? Yes__ No_X__

2. Is transmission in park? Yes__X_ No___

3. Do lights andradiowork? Yes__ X_ No____

4. Does vehicle start with a boost? Yes__ X_ No____

### PROBABLE CAUSE: DEAD BATTERY

### COMPLAINT 2: CAR WON'T START

1. Does engine “spin-over”attempting to start? Yes____ No_ X__

2. Is transmission selector in park? Yes__ X_ No____

3. Do lights and radio work? Yes_ X_ No____

4. Does vehicle start with a boost? Yes___ No_ X___

### PROBABLE CAUSE: STARTER FAILURE

The #4 question is answered differently in these two scenarios. This difference distinguishes the different probable causes.

### COMPLAINT 3: BRAKE PEDAL FEELS LOW

1. Does brake pedal height raise when pumping pedal? Yes__ X_ No____

2. Does brake pedal “sink” when stopped at traffic light? Yes____ No_ X___

3. Is brake fluid low (warning light on)? Yes____ No_ X___

### PROBABLE CAUSE: BRAKE ADJUSTMENT/SYSTEM BLEEDING REQUIRED

### COMPLAINT 4: BRAKE PEDAL FEELS LOW

1. Does brake pedal height raise when pumping pedal? Yes_ X__ No____

2. Does brake pedal “sink” when stopped at traffic light? Yes__ X_ No____

3. Is brake fluid low (warning light on)? Yes____ No_ X___

### PROBABLE CAUSE: MASTER CYLINDER FAILURE

### COMPLAINT 5: BRAKE PEDAL FEELS LOW

1. Does brake pedal height raise when pumping pedal? Yes____ No_ X___

2. Does brake pedal “sink” when stopped at traffic light? Yes_ X__ No____

3. Is brake fluid low (warning light on)? Yes__X__ No____

### PROBABLE CAUSE: HYDRAULIC LEAK (WHEEL CYLINDER, BRAKE HOSE, ETC.)

| | |
|---|---|
| Estimate: | $ 400.00 |
| Make Appointment: | Yes |
| Date & Time: | 1/30/00 @ 10:30 a.m. |
| Need Loaner: | No |
| Confirm: | 0130001030 |

At step 206 the interview obtains geographic information concerning the location of the user. This is conveyed from the user's machine to the host server. If the user does not desire an online diagnosis of the problem, as tested at step 208, then the process flow proceeds to node C of FIG. 2B to provide the user with the option of scheduling an appointment. In that case, the interview with the user need not include any questions concerning the problem with the vehicle, or can include only a selection of questions to apprize the service center of what is to be done with the vehicle.

On the other hand, if user does wish to proceed with the diagnosis of the car or other motor vehicle, then at step 210 a diagnosis is performed by applying the responses to the questions against the rule base. The result of the diagnosis is reported to the user and received at the user's machine at step 212. This can be done in a variety of ways, and most preferably is done by electronic mail or instant messaging.

At step 214, the host server accesses a data base of service centers within the geographic locale of that user. The host server locates the service centers within the user's geographic region, at step 216.

Preferably, the diagnosis made by the host server is conveyed to the local service centers as well as to the user's machine. The diagnosis can be conveyed in a variety of ways including electronic and instant messaging, as noted above, and also can be conveyed at step 218 by sending a fax to the local service center.

Referring now to FIG. 2B at step 250, the host server 110 receives price quotes from one or more service centers. These price quotes can be processed in a variety of ways at step 252, for example, by sorting them in ascending or descending price order, sorting them by zip code, or otherwise. Note also, that the price quotes can be processed at step 252 by auctioning the diagnosis amongst the participating service centers within their geographic region and securing for the user a lowest auction bid from a service center in their area. Such a reverse auction process inures purely to the benefit of the user who has visited the website that was accessed at step 202.

Optionally, the host server 110 can identify whether the required service can be performed under a factory warranty, and, if so, can advise the customer or guide the service center selection to a service center associated with a dealer of the vehicle to be serviced.

The price quote from at least one service center is provided to the user's machine at step 254. The price quote that is received at the user's machine can include both the price quote as well as a time quote as to the estimated time to perform the work. The price quote or quotes received at the user's machine can be sorted, as noted above, or could be selected using predetermine criterion, for example, so that only the lowest price quote is provided.

Optionally, the price quotes received from the participating service centers can be binding on the service center so that the user has a clear understanding of the cost of performing the work. Thus, the customer can obtain such an understanding without having to physically visit the service center.

At step 256, the central computer obtains a user's selection of the service center designated to treat the problem that was just diagnosed. In the event that no diagnosis was desired, as was tested at step 208, then a selection of service centers can be provided to the user's machine 130 using the geographic location information that was obtained at step 206. In either case, a selection of a service center is made at step 256.

At step 258, the user is permitted to schedule an appointment at the selected service center. Preferably, such permission comes after the user has identified himself or herself, for example, by a customer identification entered into the client machine 130 through the keyboard, using a selector such as a mouse, fingerprint or other biometric, magnetic stripe or ink, bar code or other machine-readable code, etc.

The ability to schedule an appointment from a client's station is a salient aspect of the invention and of the preferred embodiment. In accordance with this aspect of the invention, a dealership or other organization provides scheduling software to participating service centers which each service center can use internally as well as for receiving appointments and appointment requests from customers that access their appointments books through a distributed computer network such as the Internet. The scheduling software can be maintained by the host server 110 or can be run locally. In use, the host server relays or confirms open time slots for the user to select. The user is preferably provided with a confirmation number if an appointment is scheduled.

The user can be further prompted as to whether he or she wishes to obtain a loaner car, as tested at step 260. If the user does not wish to have a loaner car then the process can end at step 262, or account information of the user can be obtained at step 264 with the account charged for the diagnosis, for the appointment, or for other or a combination of services. The account is charged at step 266 either at the time of this session with the host server 1 10, or thereafter, for example, if the customer fails to show up for his or her appointment a charge can be placed on the account.

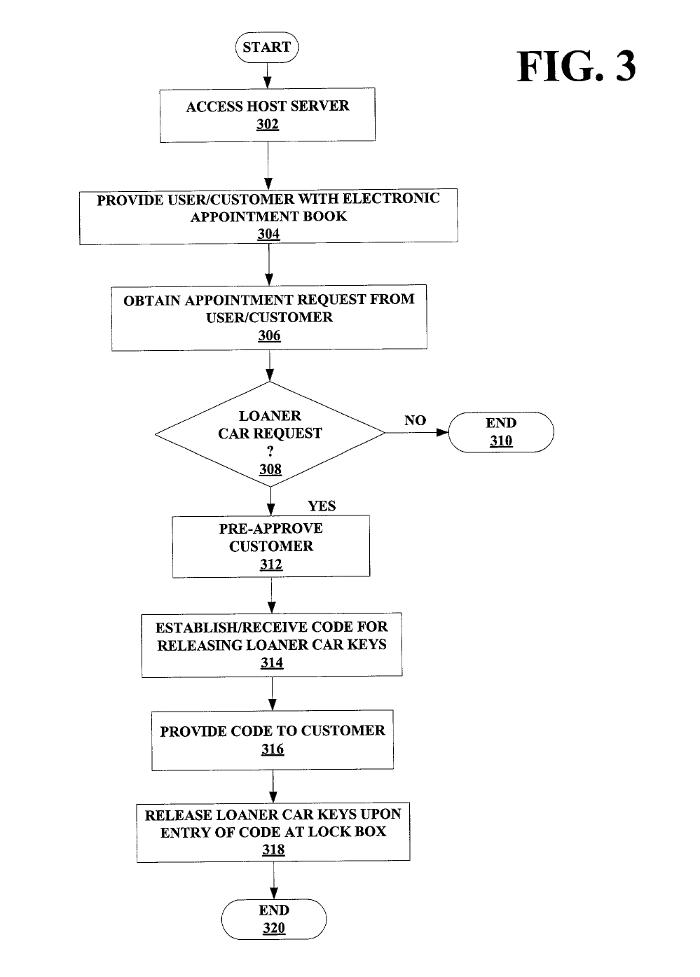

Those of skill in the art will appreciate that the foregoing processes of FIGS. 2A-2B and FIG. 3 (discussed below) represent a logical progression of steps which need not be performed in the order illustrated when the program runs in an object-oriented environment such as provided by the World Wide Web. Rather, in such object-oriented environments, process flows are dynamically driven by user input, and the steps can proceed substantially as shown, but in a different order. Thus, for example, the central computer can access the work schedules of one or more service centers in the geographic region of the user, and provide information to the user as to open time slots during which the user's vehicle can be serviced, and have that information available to the user to inform the selection of a service center, which is made at step 256.

In a further aspect of the invention, a kiosk or lock box 140 can be provided at a local service center 150 which securely dispenses keys 160 to loaner cars 170 after hours. Thus, a customer accessing the host server 110 using the process described hereinabove can receive a confirmation number or code which, when input into the lock box at the local service center, will dispense keys to a loaner car, thereby permitting the user to leave his or her vehicle on the premises for treatment early the next day. Preferably, when a loaner car 170 is to be provided to a user without interaction with personnel at the service center, the owner's drivers license, insurance card and credit card information are all provided to the system and authenticated by communications between the host server 110 and appropriate other computer servers, such as the pertinent Department of Motor Vehicles and any insurance company that the user has identified.

With reference now to FIG. 3, a method for providing a loaner car to a customer is described. At step 302, the customer accesses the host server, substantially as described above in connection with FIG. 2. Once connected to the host server from a client station or machine 130, the user is provided at step 304 with the electronic appointment book of a local service center within the geographic region of the user or customer. The particular appointment book that is shown to the customer is selected using a process as described above in connection with steps 206 and 256.

The electronic appointment book can take on a variety of forms, including a conventional calendar. The software of the electronic appointment book can be a conventional software program which is configured to work across a distributed computer network and receive appointments and other information from various sources, and forms no part of the present invention. Such software typically provides different permission levels to various users so that users on the Internet, for example, do not have the same capabilities as a manager or employee of a given service center.

At step 306, the host server obtains an appointment or appointment request from the user or customer. In addition, the host server inquires of the customer whether he or she wishes to request a loaner car. This can be done either before or after obtaining the appointment request. At step 308, the host server determines whether a loaner car request was made. If the customer has not requested a loaner car, then the process ends at step 310. Otherwise, the process proceeds through steps 312-320.

At step 312, the host server commences a process for pre-approving the loaner car request. This process includes a variety of conventional steps that are ordinarily taken prior to giving a person a loaner car. Those steps include, among others, obtaining a security deposit from the customer (e.g., a credit card imprint or card data such as card number, expiration date, name on card and billing address), driver's license information of the customer, and insurance data showing that the customer has a current vehicle insurance policy. Additional information may be required of the customer prior to pre-approving the loaner; however, all of the information that is gathered is gathered through redistributed computer network.

At step 314, the host server either establishes a code which can be used for releasing the loaner car keys, or receives a code from another source. Thus, for example, the code for releasing the loaner car keys can be the credit card number of the customer, or another code established by the host server 110. Alternatively, the host server can receive codes either from the customer or from the local service center that maintains the lock box containing the loaner car keys 160.

At step 316, the code is provided to the customer through the distributed computer network and to the customer's machine 130. In this manner, the customer now has a code which can be used at all hours of the day to obtain the keys to a loaner car. This permits the customer to drop off his or her vehicle for service at the local service center 150, access the lock box 140 using the code, release the loaner car keys 160 from the lock box (as shown at step 318) and drive away from the service center in the loaner car 170. The method ends at step 320.

Optionally, the loaner car can be provided to the customer free of any charges if prescribed conditions are met. The prescribed conditions can take on many forms, including promotions or spending thresholds which the customer must achieve in order to obtain the loaner car at no cost. If the customer purchased the vehicle being serviced at a dealership associated with the service center, this too may be a prescribed condition which entitles the customer to a loaner car without charge.

In a further aspect of the invention, the customer can retrieve keys to his or her vehicle that was being serviced using the same code, or a different code provided through the distributed computer network and to the client station. For example, the same code or further code can be provided to the customer by e-mail. The customer's original set of keys to his or her vehicle can be placed in the lock box 140 at the service center 150 so that the customer can return to the dealership or service center after hours or early in the morning to return the loaner car 170 and pick-up his or her serviced vehicle. Optionally, the lock box will not accept a code or permit the customer to retrieve his or her original set of keys unless the bill for the service appointment has been paid.

The interactive interview and other Web pages provided to the user can be sourced by the host server 110 or by a vendor machine which is connected to the Internet and which is in selective communication with the host server. Thus, for example, the appointment scheduling feature can be made available to a user through the host server 110 because it is hosted by the host server or because it is provided to the user as a redirect link, in a new active window, or as part of the content provided by the host server (e.g., within a file provided by the host server or as a file which is displayed within a frame set).

While the present invention has been described in particular regard with a preferred embodiment, it can be implemented in a variety of other ways within the spirit of the present invention. The present invention is to find by the recitations in the appended claims and equivalence thereof.

I claim:

1. A method for providing a loaner car to a customer who scheduled a service appointment for a vehicle at a service center using a machine connected to a distributed computer network, comprising the steps of:
a) providing through the machine an electronic appointment book maintained by the service center for the customer to see;
b) the customer scheduling a service appointment in the electronic appointment book;
c) prompting the customer for a loaner car; and
d) if the customer requests the loaner car,
1. pre-approving the loaner car request;
2. establishing a code for releasing car keys to the loaner car;
3. providing to the customer the code to a lock box at the service center; and
4. releasing the car keys to the customer upon entry of the code at the lock box.

2. The method as in claim 1, wherein if prescribed conditions are met by the customer, then the loaner car is provided to the customer free of cost.

3. The method as in claim 2, wherein the prescribed conditions include spending at least threshold dollar amount at the service center.

4. The method as in claim 2, wherein the prescribed conditions include that the customer have purchased the vehicle at a dealership associated with the service center.

5. The method as in claim 1, including the additional step of the customer retrieving keys to the customer's vehicle from the lock box using the code.

6. The method as in claim 5, wherein the customer's keys are only retrievable if a bill for the service appointment has been paid.

7. The method as in claim 1, wherein the code is provided to the customer by e-mail.

8. The method as in claim 1, wherein the step of pre-approving the loaner car request includes obtaining one or more of the following: a security deposit from the customer, the customer's driver's license, and information concerning the customer's vehicle insurance.

9. A method for providing a loaner car to a customer who scheduled a service appointment for a vehicle at a service center using a machine connected to a distributed computer network, comprising the steps of:
a) providing through the machine an electronic appointment book maintained by the service center for the customer to see;
b) the customer scheduling a service appointment in the electronic appointment book;
c) prompting the customer for a loaner car; and
d) if the customer requests the loaner car,
1. pre-approving the loaner car request;
2. receiving a code from a lock box at the service center;
3. providing to the customer the code to a lock box at the service center; and
4. releasing the car keys to the customer upon entry of the code at the lock box.

10. The method as in claim 9, wherein if prescribed conditions are met by the customer, then the loaner car is provided to the customer free of cost.

11. The method as in claim 10, wherein the prescribed conditions include spending at least threshold dollar amount at the service center.

12. The method as in claim 10, wherein the prescribed conditions include that the customer have purchased the vehicle at a dealership associated with the service center.

13. The method as in claim 9, including the additional step of the customer retrieving keys to the customer's vehicle from the lock box using the code.

14. The method as in claim 13, wherein the customer's keys are only retrievable if a bill for the service appointment has been paid.

15. The method as in claim 9, wherein the code is provided to the customer by e-mail.

16. The method as in claim 9, wherein the step of pre-approving the loaner car request includes obtaining one or more of the following: a security deposit from the customer, the customer's driver's license, and information concerning the customer's vehicle insurance.
